(19) United States
(12) Patent Application Publication
(10) Pub. No.: US 2025/0158095 A1
(43) Pub. Date: May 15, 2025

(54) CONDUIT AND FUEL CELL SYSTEM WITH CONDUIT

(71) Applicant: MANN+HUMMEL GmbH, Ludwigsburg (DE)

(72) Inventors: Jürgen TILG, Ittlingen (DE); Andreas WEBER, Freiberg (DE)

(21) Appl. No.: 19/019,508

(22) Filed: Jan. 14, 2025

Related U.S. Application Data
(63) Continuation of application No. PCT/EP2023/071367, filed on Aug. 2, 2023.

(30) Foreign Application Priority Data
Aug. 17, 2022 (DE) 102022120791.9

(51) Int. Cl. H01M 8/04119; H01M 8/04082; H01M 8/0662

(52) U.S. Cl. CPC H01M 8/04156; H01M 8/04201; H01M 8/0662; H01M 2250/20

(57) ABSTRACT

A conduit for discharging exhaust air from a fuel cell system, includes a fluid line including an inlet and an outlet configured to discharge the exhaust air into an environment, a turbine arranged at or in the inlet and configured to supply the exhaust air into the fluid line, a water discharge device arranged between the outlet and the inlet and configured to prevent an accidental ingress of water from the outlet into the inlet, and a drainage valve connected in fluid communication to the water discharge device. The water discharge device includes a siphon including a siphon wall having an upper edge positioned at a level higher than an installation level of the turbine.

### CROSS-REFERENCE TO RELATED APPLICATIONS

This application is a continuation application of International Application No. PCT/EP2023/071367 filed on Aug. 2, 2023, which claims the benefit of German Application No. 102022120791.9 filed on Aug. 17, 2022, the entire disclosures of which are incorporated herein by reference for all purposes.

### BACKGROUND

Embodiments concern a conduit for a fuel cell system, in particular for a vehicle operated with a fuel cell system, for discharging exhaust air from the fuel cell system as well as a fuel cell system with a conduit.

DE 10 2012 010 131 A1 discloses a device for supply of educts or for discharge of products of a fuel cell which comprises a conduit comprising a region connected to a liquid source. In intended use, this region connected by a liquid supply line to the liquid source is arranged lower than the sections of the conduit upstream and downstream of said region in flow direction. In this context, said region is embodied as a siphon in the conduit.

US 2012/0214079 A discloses a fuel cell system which suppresses a backflow of water from an exhaust air pipe outlet, which discharges a reactance exhaust gas, without reducing the performance and the fuel consumption of a fuel cell. The exhaust air pipe is configured such in this context that it switches between a main discharge pipe and an auxiliary discharge pipe by a switch device in order to discharge the reactance gas. The auxiliary outlet pipe comprises an ascending gradient section which is configured such that it is inclined upwardly above a gradient of the main outlet pipe, and a descending gradient section which is configured such that it is inclined downwardly downstream of the ascending gradient section. The switch valve switches such that it permits the discharge of the gas to be reacted from the main discharge line when a quantity of the gas to be reacted is equal to or larger than a threshold value of a discharge quantity and permits the discharge of the gas to be reacted from the auxiliary discharge line when the quantity of the gas to be reacted lies below the threshold value of the discharge quantity.

### SUMMARY

It is an object of the embodiments to provide a conduit for a fuel cell system, in particular for a vehicle operated by a fuel cell system, for discharging exhaust air from the fuel cell system, which conduit prevents the risk of a water backflow into the fuel system.

A further object resides in providing a fuel cell system with such a conduit.

The aforementioned object is solved according to an aspect of the embodiments with a conduit for a fuel cell system, in particular for a vehicle operated with a fuel cell system, for discharging exhaust air from the fuel cell system, comprising at least one fluid line with an inlet and with an outlet, wherein the outlet is configured for discharging the exhaust air into the environment, in particular below a waterline, in particular below a fording depth of the vehicle, wherein a water discharge device for preventing an accidental water ingress from the outlet into the inlet is arranged between outlet and inlet of the fluid line, wherein the water discharge device is connected in fluid communication to at least one drainage valve.

According to a further aspect of the embodiments, the further object is solved by a fuel cell system with a cathode supply air path and a cathode exhaust air path of a fuel cell unit and with at least one conduit.

Beneficial embodiments and advantages result from the additional claims, the description, and the drawing.

According to an aspect of the embodiments, a conduit for a fuel cell system, in particular for a vehicle operated with a fuel cell system, for discharging exhaust air from the fuel cell system is proposed, comprising at least one fluid line with an inlet and with an outlet, wherein the outlet is configured for discharging the exhaust air into the environment, in particular below a waterline, in particular below a fording depth of the vehicle. In this context, a water discharge device for preventing an accidental water ingress from the outlet into the inlet is arranged between outlet and inlet of the fluid line, wherein the water discharge device is connected in fluid communication to at least one drainage valve.

In this context, the conduit can advantageously be installed in an exhaust air device of a fuel cell system, in particular of a vehicle operated with a fuel cell system, in order to discharge the exhaust air of the fuel cell system from a turbine into the environment. When the outlet of the conduit is arranged below a waterline, in particular below the fording depth of the vehicle, there is the risk, in particular when a vehicle is fording, that water penetrates into the exhaust air system opposite to the flow direction of the exhaust air and flows in the direction toward the turbine. Components in the exhaust air system and in particular the turbine could become permanently damaged in this way.

The proposed conduit comprises a water discharge device with at least one drainage valve which minimizes this risk because penetrated water, for example, is guided into an overflow container of the water discharge device or is prevented by a siphon of the water discharge device from reaching the entry of the conduit with the turbine. Penetrated water can be discharged via the at least one drainage valve from the overflow container or the siphon region. In this manner, the backflow of water into the fuel cell system can be advantageously avoided.

According to a beneficial embodiment of the conduit, an acoustic damping device can be integrated in the water discharge device. The turbine which conducts the exhaust air into the fluid line can generate a strong acoustic excitation of the exhaust air flow. With an acoustic damping device, for example, in the form of a Helmholtz resonator or a broadband damping device, the generated noise can be effectively damped. Due to the integration of the acoustic damping device into the water discharge device, installation space can be effectively saved. Furthermore, this may result advantageously in cost savings compared to separate individual solutions.

According to a beneficial embodiment of the conduit, the at least one drainage valve can be connected hydraulically to a pump for discharging the water. Penetrated water can be discharged from the conduit via the drainage valve. The water can be discharged particularly effectively when the drainage valve is connected to a pump which can suck away the water. Alternatively, the water can also be blown out through the drainage valve.

According to a beneficial embodiment of the conduit, a conveying means for supply of the exhaust air into the fluid line can be arranged at or in the inlet. In particular, the conveying means can be a turbine. In a fuel cell system, usually the exhaust air is blown out by means of a turbine or another fluidic conveying means. The turbine is integrated usually as a part of the fuel cell system. As an alternative, the turbine can also be a component of the conduit.

According to a beneficial embodiment of the conduit, inlet and outlet can be arranged vertically offset. In particular, the inlet can be arranged above the outlet in the gravitational force direction in this context. In this manner, the inlet can be already partially protected from a backflow of water by the action of the gravitational force.

As an alternative, it is however also possible to arrange inlet and outlet at the same level. In this case, higher requirements are imposed on the water discharge device in regard to protecting the inlet of the fluid line from backflow of water, in particular in fording operation of a vehicle. A possibility is provided in this context by a siphon as a water discharge device.

According to a beneficial embodiment of the conduit, a water level sensor can be arranged in the fluid line, in particular spatially adjacent to the outlet, in particular at a level of the outlet. A water level sensor can provide additionally a signal that water has penetrated into the fluid line. In this manner, a pump for conveying the water out of the drainage valve can be actuated, for example.

According to a beneficial configuration of the conduit, the water discharge device can comprise an overflow container. In this context, the drainage valve can be arranged in particular at a lowest point of the overflow container. In this way, penetrated water can be advantageously caught first and then discharged through the drainage valve. When the drainage valve is arranged at the lowest point of the overflow container, the overflow container can be reliably emptied due to the gravitational force after the waterline has dropped, in particular after a vehicle has completed fording. By means of an additional pump at the drainage valve, the water can be discharged also during fording.

According to a beneficial embodiment of the conduit, the overflow container can comprise at least one resonator chamber, which is connected in fluid communication to the fluid line, as an acoustic damping device for acoustic damping of the exhaust air flow. In particular, the overflow container can be configured as a Helmholtz resonator in this context. With such a Helmholtz resonator, noises that are caused by the turbine and/or the flow conduction can be effectively damped.

According to a beneficial configuration of the conduit, the overflow container can comprise a plurality of resonator chambers, which are connected in fluid communication to the fluid line, as acoustic damping device for acoustic damping of the exhaust air flow. In particular, the overflow container can be configured as a multi-chamber resonator in this context. In contrast to a single chamber resonator, noises caused by the turbine and/or the flow conduction can be particularly effectively damped at several frequencies and/or across a larger frequency range by means of a multi-chamber resonator.

According to a beneficial embodiment of the conduit, the overflow container can comprise a plurality of resonator chambers as acoustic damping device which are arranged at the same level and/or at different levels of the fluid line. In particular, the overflow container can be configured as a broadband damping device in this context. By means of a broadband damping device, noises caused by the turbine and/or the flow conduction can be particularly effectively dampened across a broad frequency range.

According to a beneficial configuration of the conduit, the resonator chambers can be arranged so as to surround the fluid line in a hollow cylinder shape and can be connected in fluid communication to the fluid line via wall openings. In such a configuration, a broadband damping device can be particularly effectively arranged around the fluid line and can be connected in fluid communication via individual wall openings with the fluid flow in the fluid line. Such an arrangement is referred to also as a 360° damping device. For such an arrangement, it is particularly advantageous when the conduit comprises a water discharge device because resonator chambers, which are lying lower than the fluid line, could become filled with water. For the proposed configuration, this can be advantageously prevented in that a drainage valve is arranged in the resonator chambers which are positioned lower.

According to a beneficial embodiment of the conduit, an overflow valve can be arranged in a resonator chamber above the outlet. In addition, an additional drainage valve can be arranged also at a resonator chamber which is positioned higher in order to be able to discharge the water again even there, for example, in case of a fast water ingress reaching also resonator chambers positioned higher.

According to a beneficial embodiment of the conduit, the water discharge device can be designed as a siphon and arranged so as to be integrated in the fluid line, wherein an upper edge of a siphon wall is positioned at a level which is higher than an installation level of the turbine in the fluid line. A siphon arrangement can effectively prevent that a water backflow, for example, in case of fording of a vehicle operated with a fuel cell system, can reach an inlet of the fluid line which is arranged at the same level as the outlet.

According to a beneficial embodiment of the conduit, at least two siphons can be arranged one after another in an exhaust air flow direction. The arrangement of a plurality of siphons in the fluid line one after another can provide an increased safety against ingress of water into a turbine of the fuel cell system due to water backflow, in particular in case of fording of a vehicle operated with a fuel cell system, because the accommodation volume for water is correspondingly enlarged in case of a plurality of siphons.

According to a beneficial embodiment of the conduit, a plurality of resonator chambers of a resonator can be arranged as an acoustic damping device downstream of the one or the at least two siphons in the fluid line. Due to the plurality of resonator chambers, noises produced by the turbine and/or the flow conduction in the fluid line can be damped effectively in a broadband frequency range.

According to a beneficial embodiment of the conduit, the resonator chambers can be arranged so as to at least partially surround the fluid line and/or can be connected in fluid communication to the fluid line via wall openings. With such an arrangement of resonator chambers in which the resonator chambers surround the fluid line in a semicircular shape in cross section, the noises of the exhaust airflow can be damped advantageously in a broadband range. Such an arrangement is also referred to as a 180° damping device.

According to a beneficial embodiment of the conduit, the drainage valve can be arranged at one of the resonator chambers. In particular, the drainage valve can be arranged in this context at a level which is lower than a level of the upper edge of the siphon wall. In this way, it can be ensured that penetrated water can drain through the drainage valve before the critical level of the upper edge of the siphon wall is reached.

According to a further aspect of the embodiments, a fuel cell system is proposed with a cathode supply air path and a cathode discharge air path of a fuel cell unit and with at least one conduit as described above.

The conduit can advantageously be installed in an exhaust air device of the fuel cell system, in particular in an exhaust air device of a vehicle operated with the fuel cell system, in order to discharge the exhaust air of the fuel cell system from a turbine into the environment. When the outlet of the conduit is arranged below a waterline, in particular below the fording depth of the vehicle, there is the risk, in particular in case of fording, that the water penetrates into the exhaust air system opposite to the flow direction of the exhaust air and flows in the direction toward the turbine. Components in the exhaust air system and in particular the turbine can become permanently damaged thereby.

The conduit comprises a water discharge device with at least one drainage valve which minimizes this risk because penetrated water is guided, for example, into an overflow container of the water discharge device, or is prevented from reaching the entry of the conduit with the turbine due to a siphon of the water discharge device. Penetrated water can be discharged via the at least one drainage valve from the overflow container or from the siphon region. In this manner, the backflow of water into the fuel cell system can be advantageously avoided.

### BRIEF DESCRIPTION OF DRAWINGS

Further advantages result from the following drawing description. In the drawings, the embodiments are illustrated. The drawings, the description, and the claims contain numerous features in combination. A person of skill in the art will consider the features expediently also individually and combine them to expedient further combinations.

FIG. 1 is a schematic longitudinal section of a conduit according to an embodiment for a vehicle operated with a fuel cell system for discharging exhaust air from the fuel cell system with an overflow container and a Helmholtz resonator.

FIG. 2 is a schematic front view of the conduit according to FIG. 1.

FIG. 3 is a schematic longitudinal section of a conduit according to a further embodiment with an overflow container and a multi-chamber resonator.

FIG. 4 is a schematic front view of the conduit according to FIG. 3.

FIG. 5 is a schematic longitudinal section of a conduit according to a further embodiment with an overflow container and a broadband damping device.

FIG. 6 is a schematic front view of the conduit according to FIG. 5.

FIG. 7 is a schematic longitudinal section of a conduit according to a further embodiment with a siphon and a multi-chamber resonator.

FIG. 8 is a schematic front view of the conduit according to FIG. 7.

FIG. 9 is a schematic longitudinal section of a conduit according to a further embodiment with two siphons arranged one after another and a multi-chamber resonator.

FIG. 10 is a schematic front view of the conduit according to FIG. 9.

FIG. 11 is a simplified illustration of a fuel cell system with cathode supply air path and cathode exhaust air path.

### DETAILED DESCRIPTION

In the FIGS., same or same-type components are identified with same reference characters. The FIGS. show only examples and are not to be understood as limiting.

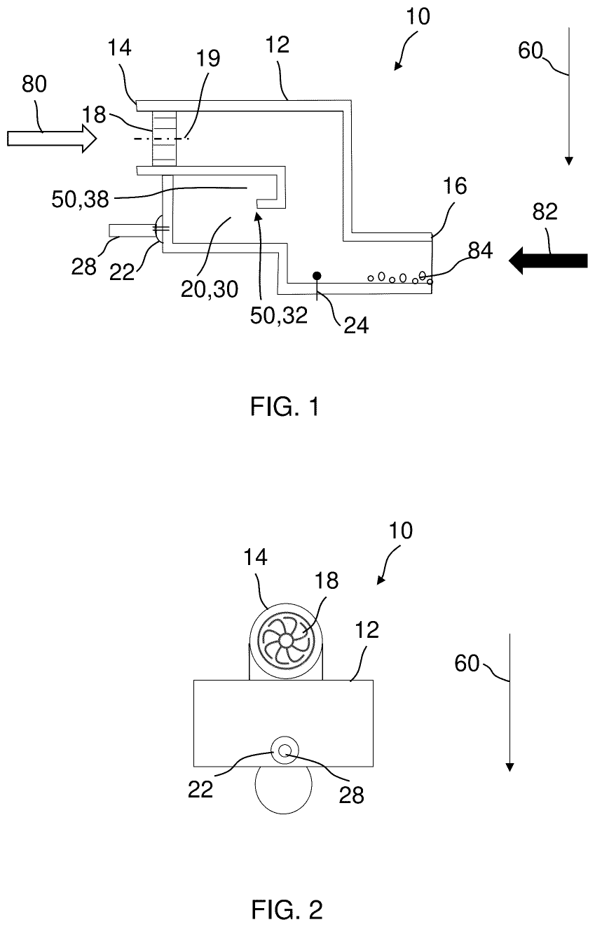

FIG. 1 shows a schematic longitudinal section of a conduit 10 according to an embodiment for a vehicle operated with a fuel cell system 100 for discharging exhaust air from the fuel cell system 100, provided with an overflow container 30 and a Helmholtz resonator 32, while in FIG. 2 a schematic front view of the conduit 10 according to FIG. 1 is illustrated.

The conduit 10 comprises a fluid line 12 with an inlet 14 and with an outlet 16. The outlet 16 is configured for discharging the exhaust air of the fuel cell system into the environment. Inlet 14 and outlet 16 are arranged vertically offset. In particular, the inlet 14 is arranged above the outlet 16 in the gravitational force direction 60.

When installed in a vehicle, the outlet 16 can be arranged below a fording depth of the vehicle. For this reason, in a fording operation of the vehicle, water can penetrate through the outlet 16 into the fluid line 12 and possibly reach the inlet 14. Penetrated water 84 is indicated symbolically in the fluid line 12 in the vicinity of the outlet 16. The water inflow direction 82 is identified by an arrow.

At or in the inlet 14, a conveying means 18 for supply of the exhaust air into the fluid line 12 can be arranged, usually a turbine, as illustrated in the embodiment in FIGS. 1 and 2. The exhaust air flow direction 80 is illustrated by an arrow.

In the embodiments illustrated in FIGS. 1 through 10, the turbine 18 is illustrated integrated into the inlet 14 as a part of the conduit 10, respectively. The turbine 18 however could also be arranged upstream of the conduit 10 as a part of the fuel cell system 100.

A water ingress into the turbine 18 and/or components of the fuel cell system 100 arranged upstream, not illustrated, could cause significant damage in the turbine and/or the components.

For this reason, a water discharge device 20 is arranged between outlet 16 and inlet 14 of the fluid line 12 for preventing an accidental water ingress from the outlet 16 into the inlet 14. The water discharge device 20 is connected in fluid communication to at least one drainage valve 22.

The water discharge device 20 comprises an overflow container 30. The drainage valve 22 is arranged at a lowest point of the overflow container 30 in relation to an illustrated gravitational force direction 60. For discharging the water, the drainage valve 22 can be additionally hydraulically connected to a pump with which the water can be sucked away. For this purpose, a pump line 28 is indicated in FIGS. 1 and 2. The drainage valve 22 can be formed, for example, as a conventional mushroom valve or as a duckbill valve.

A water level sensor 24 is arranged in the fluid line 12 spatially adjacent to the outlet 16, in particular at the level of the outlet 16. The water level sensor 24 can deliver in addition a signal that water has penetrated into the fluid line 12. In this manner, for example, the pump for discharging the water from the drainage valve 22 can be activated.

Furthermore, an acoustic damping device 50 is integrated in the water discharge device 20. For this purpose, the overflow container 30 comprises at least one resonator chamber 38, which is connected in fluid communication to the fluid line 12, for acoustic damping of the exhaust air flow. In particular, the overflow container 30 can thus be embodied as a Helmholtz resonator 32.

The overflow container 30 fulfills thus several functions. On the one hand, it accommodates water of water backflow which penetrates into the outlet 16 in case of fording of the vehicle and discharges the water again through the drainage valve 22. In addition, the upper region of the overflow container 30 serves as an acoustic damping device 50 because here a resonator chamber 38 is arranged which is open toward the fluid line 12. Due to the integration of water discharge device 20 and acoustic damping device 50, a compact configuration of the conduit 10 can be enabled and, advantageously, installation space and costs saved.

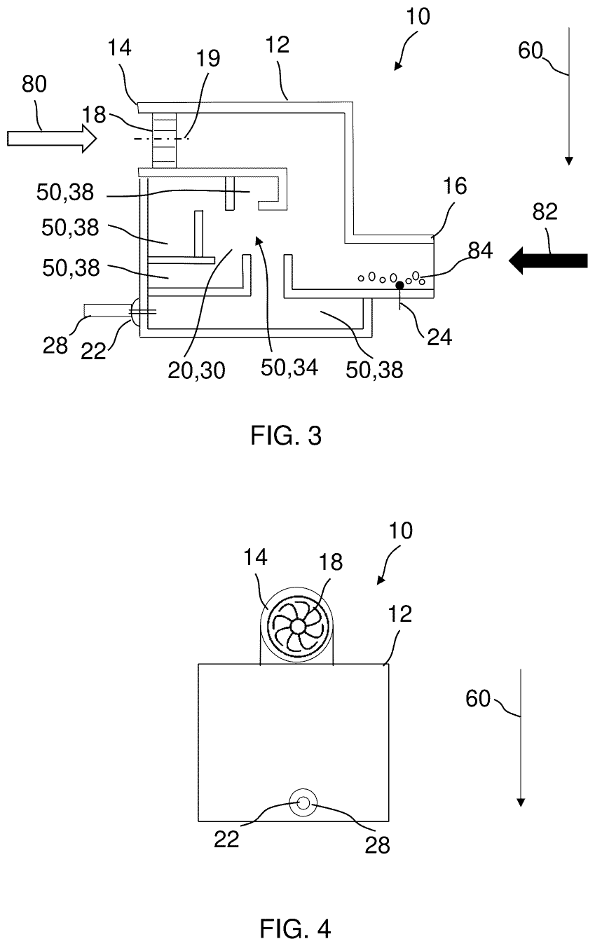

FIG. 3 shows a schematic longitudinal section of a conduit 10 according to a further embodiment with an overflow container 30 and a multi-chamber resonator 34, while in FIG. 4 a schematic front view of the conduit 10 according to FIG. 3 is illustrated.

The function of the water discharge device 20 is realized in a similar manner as in the embodiment of FIGS. 1 and 2. The overflow container 30 comprises however a plurality of resonator chambers 38, which are connected in fluid communication to the fluid line 12, for acoustic damping of the exhaust air flow—The overflow container 30 is embodied thus as a multi-chamber resonator 34. The resonator chambers 38 can be formed, for example, as λ/4 pipes for different frequencies. One resonator chamber 38 is arranged below the level of the outlet 16. The drainage valve 22 is expediently arranged in this resonator chamber 38 as the lowest point of the conduit 10.

A water level sensor 24 is arranged in the fluid line 12 in the vicinity of the outlet 16.

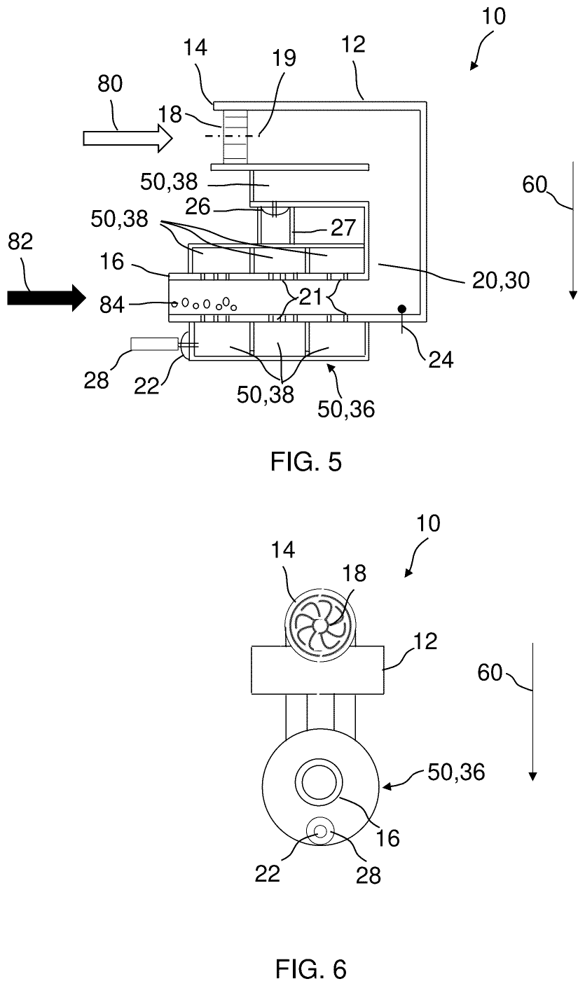

In FIG. 5, a schematic longitudinal section of a conduit 10 according to a further embodiment is illustrated with an overflow container 30 and a broadband damping device 36, while in FIG. 6 a schematic front view of the conduit 10 according to FIG. 5 is illustrated.

The overflow container 30 comprises in this embodiment a plurality of resonator chambers 38 which are arranged at the same level and/or at different levels of the fluid line 12. The resonator chambers 38 comprise different dimensions. Some of the resonator chambers 38 are arranged so as to surround the fluid line 12 in a hollow cylinder shape and are connected in fluid communication to the fluid line 12 via wall openings 21. The wall openings 21 can be designed with small diameters. In this context, each resonator chamber 38 is connected in fluid communication via several wall openings 21 to the fluid line 12. In this context, some of the resonator chambers 38 are arranged below the level of the outlet 16 because the resonator chambers 38 surround the fluid line 12 in a hollow cylinder shape. The drainage valve 22 is arranged in one of the lowermost resonator chambers 38. The overflow container 30 is advantageously configured as a broadband damping device 36.

A further valve can be expediently arranged as an overflow valve 26 above the outlet 16 in order to thus also discharge water, which has penetrated up to an upper resonator chamber 38 of the overflow container 30, to an overflow pipe 27.

A water level sensor 24 is arranged here farther inwardly in the fluid line 12 but at the level of the outlet 16.

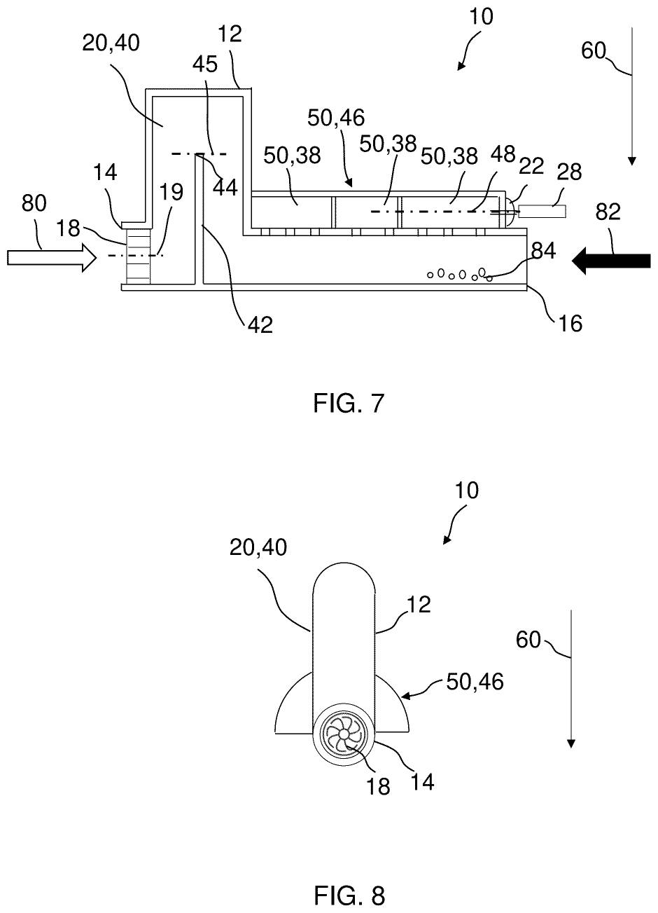

FIG. 7 shows a schematic longitudinal section of a conduit 10 according to a further embodiment with a siphon 40 and a multi-chamber resonator 46, while FIG. 8 shows a schematic front view of the conduit 10 according to FIG. 7.

The water discharge device 20 in this embodiment is integrated as a siphon 40 in the fluid line 12. Inlet 14 and outlet 16 of the fluid line 12 are arranged at the same level. An upper edge 44 of a siphon wall 42 of the siphon 40 is positioned at a level 45 which is higher than an installation level 19 of the turbine 18 in the fluid line 12. In this way, water 84 which has penetrated through the outlet 16 can be prevented from reaching the inlet 14 at least until it rises above the level of the upper edge 44.

As acoustic damping device 50, a plurality of resonator chambers 38 of the resonator 46 are arranged downstream of the siphon 40 at the fluid line 12. The resonator chambers 38 surround the fluid line 12 in a semicircular shape in cross section and are connected in fluid communication to the fluid line 12 via wall openings 21. With such a so-called 180° damping device, a broadband damping of the generated noises of the exhaust air flow can be achieved.

The drainage valve 22 is arranged at one of the resonator chambers 38, namely expediently at a level 48 which is lower than a level 45 of the upper edge 44 of the siphon wall 42. In this way, penetrated water can be discharged advantageously.

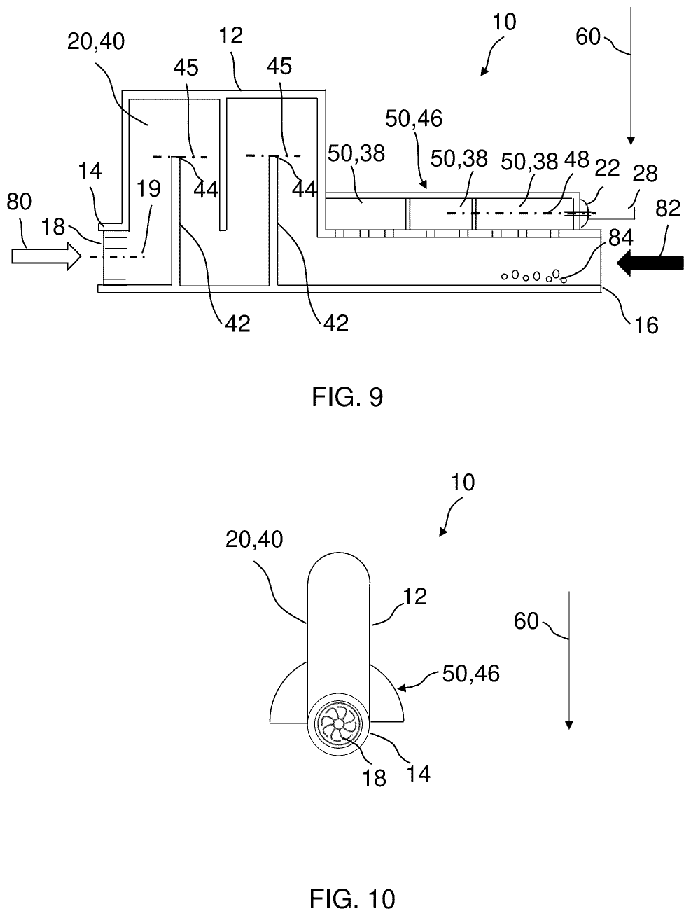

FIG. 9 shows a schematic longitudinal section of a conduit 10 according to a further embodiment with two siphons 40 arranged one after another and a multi-chamber resonator 46, while in FIG. 10 a schematic front view of the conduit 10 according to FIG. 9 is illustrated.

In this embodiment, two siphons 40 are arranged one after another in an exhaust air flow direction 80. For such an arrangement, water which has flowed across the upper edge 44 of the first siphon wall 42 can be prevented from reaching the inlet 14 with the turbine 18 by the second siphon 40.

The arrangement of the acoustic damping device 50 corresponds to the embodiment illustrated in FIGS. 7 and 8.

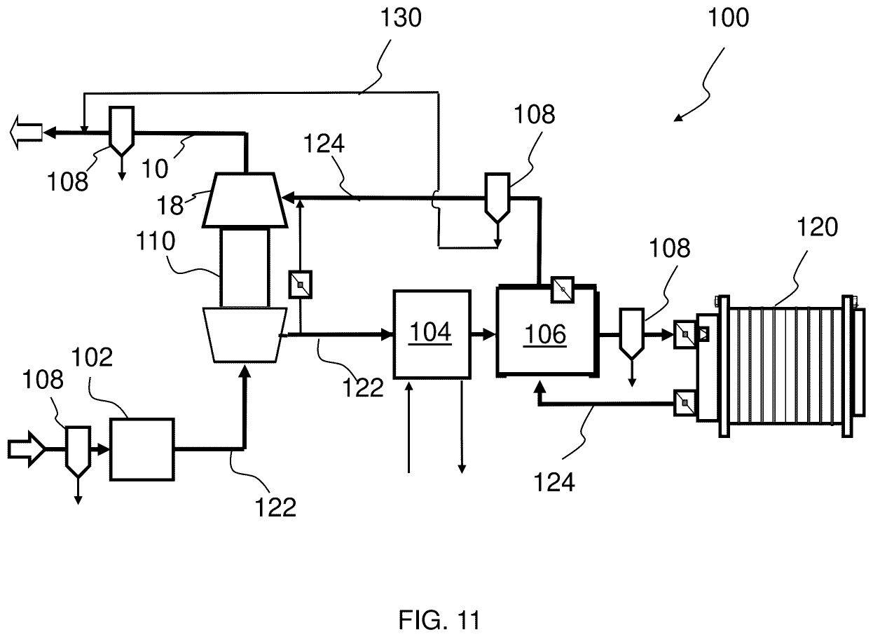

FIG. 11 shows a simplified illustration of a generally known fuel cell system 100 with a fuel cell unit 120 with a cathode supply air path 122 and a cathode exhaust air path 124. Through the cathode supply air path 122, the fuel cell unit 120 is supplied with ambient air which is filtered by a cleaning stage 102 and sucked in and compressed by a compressor of a turbocharger 110. The compressed air is cooled down in a heat exchanger 104 and provided with a defined moisture by a humidifier 106.

In the fuel cell unit 120, the oxygen from the air reacts with the hydrogen to water which is discharged as an air/water mixture via the cathode exhaust air path 124 from the fuel cell unit 120. The cathode exhaust air can transfer a portion of the water in the humidifier 106 to the cathode supply air. A water separator 108 is connected downstream of the humidifier 106. The separated water is discharged in a drainage path 130 while the dried cathode exhaust air is supplied to the turbine 18 of the turbocharger 110. Positioning the water separator 108 upstream of the turbine of the turbocharger 110 is particularly beneficial. Further water separators 108 are arranged in the fuel cell system 100.

Via the conduit 10, the exhaust air is discharged from the turbine 18 of the turbocharger 110 into the environment. In this context, an additional water separator can be integrated optionally into the conduit 10. The conduit 10, as described in the embodiments illustrated in FIGS. 1 to 10, can comprise a water discharge device 20 which prevents water backflow into the turbine 18. In addition, the conduit 10 can comprise an acoustic damping device 50 as described above which effects an effective damping of the noises caused by the turbine 18 and/or the flow conduction.

1. A conduit for discharging exhaust air from a fuel cell system, the conduit comprising:
a fluid line comprising an inlet and an outlet configured to discharge the exhaust air into an environment;
a turbine arranged at or in the inlet and configured to supply the exhaust air into the fluid line;
a water discharge device arranged between the outlet and the inlet and configured to prevent an accidental ingress of water from the outlet into the inlet; and
a drainage valve connected in fluid communication to the water discharge device,
wherein the water discharge device comprises a siphon comprising a siphon wall having an upper edge positioned at a level higher than an installation level of the turbine.

2. The conduit according to claim 1, wherein the drainage valve is connected hydraulically to a pump for discharging the water.

3. The conduit according to claim 1, wherein the siphon comprises a plurality of siphons arranged one after another in an exhaust air flow direction.

4. The conduit according to claim 1, further comprising, as an acoustic damping device, a resonator comprising a plurality of resonator chambers arranged downstream of the siphon along the fluid line.

5. The conduit according to claim 4, wherein the plurality of resonator chambers are arranged to at least partially surround the fluid line and are connected in fluid communication to the fluid line via a plurality of wall openings.

6. The conduit according to claim 4, wherein the drainage valve is arranged at one of the plurality of resonator chambers and at a level lower than the level of the upper edge of the siphon wall.

7. A fuel cell system comprising:
a fuel cell unit;
a cathode supply air path of the fuel cell unit;
a cathode exhaust air path of the fuel cell unit; and
a conduit for discharging exhaust air from the fuel cell system, the conduit comprising:
a fluid line comprising an inlet and an outlet configured to discharge the exhaust air into an environment;
a turbine arranged at or in the inlet and configured to supply the exhaust air into the fluid line;
a water discharge device arranged between the outlet and the inlet and configured to prevent an accidental ingress of water from the outlet into the inlet; and
a drainage valve connected in fluid communication to the water discharge device,
wherein the water discharge device comprises a siphon comprising a siphon wall having an upper edge positioned at a level higher than an installation level of the turbine.
